(19) United States
(12) Patent Application Publication
(10) Pub. No.: US 2007/0147412 A1
(43) Pub. Date: Jun. 28, 2007

(54) Automatic configuration system and method

(76) Inventors: Chun-Wang Wei, Hsin Chu (TW); Ming-Chou Yen, Hsin Chu (TW); Kun-Ying Tsai, Hsing Chu (TW)

Correspondence Address: SAWYER LAW GROUP LLP, P O BOX 51418, PALO ALTO, CA, 94303, US

(21) Appl. No.: 11/430,664

(22) Filed: May 9, 2006

(30) Foreign Application Priority Data
Nov. 21, 2005 (TW) 094140760

(51) Int. Cl. H04L 12/66; H04L 12/28

(52) U.S. Cl. 370/463; 370/254

(57) ABSTRACT

An automatic configuration system and method is provided. A detecting unit is used to detect whether a signal indicating link establishment appears at a first connector or a second connector, which serves as a receiving terminal of a node device, and accordingly generate a detecting result. Thus, according to the detecting result, an automatic configuration control unit controls a switching unit to execute a corresponding switching operation and sequentially configure the first connector and the second connector, so as to ensure that data can be transmitted and received reliably in the communication network and to save power.

### CROSS-REFERENCE TO RELATED APPLICATIONS

This application claims benefit under 35 USC 119 of Taiwan Application No. 094140760, filed on Nov. 21, 2005.

### FIELD OF THE INVENTION

The present invention relates generally to an automatic configuration system and method, and more particularly, to an automatic configuration system and method applicable in a communication network having transmitting and receiving functions that can automatically configure transmitting and receiving pins of a connecting interface of a node device in the communication network. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

### BACKGROUND OF THE INVENTION

Currently many communication networks, such as Local Area Network (LAN) etc., with transmitting and receiving functionalities employ media that may include a copper twisted pair to simultaneously transmit/receive data, which requires at least a copper twisted pair for receiving data and at the same time at least a copper twisted pair for receiving data. Two node devices in a LAN transmit/receive data between each other via a link. For example, in a LAN using a full-duplex medium, different copper wires are used for transmitting and receiving data. Thus, twisted pair at the terminal of each link needs to have a fixed corresponding twisted pair. For example, in a star-based network, a Network Interface Card (NIC) is often used as a node device; a switch or repeater is used as a connector. For links to properly operate, the NIC must transmit data over a twisted pair which connects to a receiver of a network hub or switch. Meanwhile, the receiver of the NIC is connected to the transmitter of the device at the other end of the link. If the twisted pair for transmitting data of a device is connected to the transmitting connector of another device, then the connection of the two devices is doomed to fail.

Most LAN standards assigns different connector pins to the copper wires in the twisted pairs. The twisted pair is called a Medium Dependent Interface (MDI). In the IEEE 802.3 10Base-T standard, a terminal node assigns pins P1 and P2 to a twisted pair for transmitting data, and pins P3 and P6 to a twisted pair for receiving data. For a 10 Base-T network, a hub functioning as a repeater or a switch assigns its transmitter pins P3 and P6 and its receiver pins P1 and P2. In the case of connecting a network interface card to a repeater, such designation is fine. However, several problems still exist, which become more prominent for a switching network. When a network interface card is directly connected to another network interface card or a repeater connected to another repeater or a repeater connected to a switch, according to the standard pin designation of network interface, crossovers are necessary since two local network products have the same pin designation on its interface.

According to the shortcomings of the above prior art, bus switches are developed as cross-typed circuits that use low frequency to automatically switch between pins. However, this kind of product has the following disadvantage: when two devices of this type are connected together, each device may enter into a “lock step”, such that communication linkage cannot be established between them. In order to eliminate the phenomenon of “lock step”, developed LAN products using a similar algorithm are forced to operate in different switching frequency.

FIG. 1 shows a schematic connecting architecture of a conventional 10 Base-T Medium Dependent Interface (MDI). As shown, the connecting architecture is provided between a network interface card (NIC) 10 and a hub interface 12. A transmit pair of the NIC 10 is connected to its pins P1 and P2. The pins P1 and P2 of the NIC 10 are connected to pins P1 and P2 of the hub interface 12 via a twisted pair 14. A receive pair of the NIC 10 is connected to its pins P3 and P6. The pins P3 and P6 of the NIC 10 are connected to pins P3 and P6 of the hub interface 12 via a twisted pair 16.

FIG. 2 shows another schematic connecting architecture between conventional network devices (e.g. a repeater or switch or hub interface). In this conventional connecting architecture, the network devices are, for example, two connecting hub interfaces (12, 12′). However, the interfaces of these conventional network devices have the same designations such that data cannot be received or transmitted from/to the other end. Thus, cross connection is required, that is, pins P1 and P2 of a transmit pair of the hub interface 12′ are connected to pins P3 and P6 of a receive pair of the hub interface 12 via a twisted pair 14; similarly, pins P3 and P6 of a receive pair of the hub interface 12′ are connected to pins P1 and P2 of a transmit pair of the hub interface 12 via a twisted pair 16.

In view of the above drawbacks, U.S. Pat. No. 6,460,078 discloses a device for automatically configuring connecting pins of media connectors. Referring to FIG. 3, shown is a schematic diagram in which a repeater, a switch or a hub interface 12 connects to a media switch 20 via connecting lines 28, 36. As shown, media switch 20 includes a transmitting end 22, receiving end 24 and four pairs of contacts 26 for allowing the transmitting end 22 to connect to pins P1, P2 of the receive pair of the interface 12, and the receiving end 24 to connect to pins P3, P6 of the transmit pair of the interface 12. As described above, the four pairs of contacts 26 are selectively connected to the pins of the transmit pair and the receive pair of the hub interface 12 via switching elements.

Additionally, the conventional device for automatically configuring connecting pins of media connectors further comprises a processor 34, a shift register 30 and a OR gate 32. The processor 34 is connected to the media switch 20 and the shift register 30. The processor 34, the shift register 30 and the OR gate 32 work cooperatively to switch the contacts 26 of the media switch 20. The processor 34 includes a signal detector for detecting signals on the receiving end 24. The processor also includes a clock for clocking the shift register 30. The shift register 30 is, for example, an analog free-running A-timer for resetting the device that includes the shift register 30. The shift register 30 reduces the occurrence of “lock step” for network devices initialized at different time.

U.S. Pat. No. 6,661,805 discloses a system and method for automatically changing device transmission/reception configurations. In system runtime, the transmission/reception configuration of Ethernet devices are disabled or initialized, then a controller determines whether there is an Ethernet link between Ethernet devices, if an Ethernet link is not yet established, then the controller periodically switches the transmission/reception configurations of the Ethernet devices until an Ethernet link is detected.

In the above techniques, “lock step” phenomenon can avoided by randomly switching transmission/reception configurations so as to ensure guaranteed transmission/reception to data between network devices. However, in the above techniques, power has to be provided to configure the connections of lines for transmission and reception with contact pins P1, P2 and contact pins P3 and P6. Thus, power consumption is greater with this kind of design.

Therefore, there is a need for an automatic configuration system for automatically configuring a connecting interface of a node device on a network which eliminates unreliable transmission/reception of data and reduces power consumption issues in the prior art.

### SUMMARY OF THE INVENTION

In the light of forgoing drawbacks, an objective of the present invention is to provide an automatic configuration method and system for automatically configuring connecting interfaces of node devices in a communication network to ensure reliable data transmission/reception between the node devices in the communication network.

Another objective of the present invention is to provide an automatic configuration method and system for automatically configuring connecting interfaces of node devices in a communication network to save power.

In accordance with the above and other objectives, the present invention provides an automatic configuration system and method. The automatic configuration system is used for automatically configuring a connecting interface of a node device on a communication network, wherein the node device comprises at least a transmitting line pair for transmitting data and a receiving line pair of receiving data, and the connecting interface of the node device comprises at least a first connector and a second connector, one of the connectors being preset for transmitting data and the other for receiving, the first connector and the second connector selectively connecting to the transmitting line pair and the receiving line pair to allow the first and second connectors of the node device to couple to a connecting interface of another node device on the communication network so as exchange data. The automatic configuration system comprises: a detecting unit for detecting whether a signal indicating link establishment appears at the receiving line pair in a predetermined time so as to detect whether the signal indicating link establishment appears at one of the first connector and the second connector preset for receiving data; an automatic configuration control unit for generating a control signal based on a detection result by the detecting unit; and a switching unit for selectively connecting the first connector and the second connector to the transmitting line pair and the receiving line pair at a predetermined timing based on the control signal generated by the automatic configuration control unit.

In one embodiment of the automatic configuration system of the present invention, the first connector and the second connector are preset to connect to the transmitting line pair and the receiving line pair, respectively, then the detecting unit detects whether the signal indicating link establishment appears at the second connector preset for receiving data, if so, then the current configuration of the connecting interface is maintained; else, the automatic configuration control unit controls the switching unit to perform switching based on the detection result of the detecting unit so that the first connector is switched from the transmitting line pair to the receiving line pair and the second connector is disabled, then in a next predetermined time, the detecting unit further detects whether the signal indicating link establishment appears at the first connector, if so, then the automatic configuration control unit controls the switching unit to perform switching so as to connect the second connector to the transmitting line pair.

The node device can be one of a Network Interface Card (NIC), a switch, a repeater and a hub. The first connector and the second connector may respectively be a plurality of pins of the node device.

The automatic configuration method is used for automatically configuring a connecting interface of a node device on a communication network, wherein the node device comprises at least a transmitting line pair for transmitting data and a receiving line pair of receiving data, and the connecting interface of the node device comprises at least a first connector and a second connector selectively connecting to the transmitting line pair and the receiving line pair to allow the first and second connectors of the node device to couple to a connecting interface of another node device on the communication network so as exchange data. The automatic configuration method comprises the following steps:

(1) presetting one of the first and second connectors to connect to the transmitting line pair and the other one of the first and second connectors to connect to the receiving line pair, then executing step (2);

(2) detecting whether a signal indicating link establishment appears at the receiving line pair in a predetermined time, if so, maintaining the preset connections, else generating a control signal to switch the one of the first and second connectors preset to connect to the receiving line pair to the transmitting line pair and disable the other one of the first and second connectors, and executing step (3); and

(3) detecting whether the signal indicating link establishment appears at the receiving pair, if so, generating a control signal to switch the other one of the first and second connectors preset to connect to the transmitting line pair to the receiving line pair; else repeating step (3).

In one embodiment, the first connector is preset to connect to the transmitting line pair and the second connector are preset to connect to the receiving line pair. The step (2) thus comprises detecting whether the signal indicating link establishment appears at the second connector, if so, then maintaining the current configuration; else, the first connector is switched from the transmitting line pair to the receiving line pair and the second connector is disabled, then after a predetermined time, in the step (3), detecting whether the signal indicating link establishment appears at the first connector, if so, then connecting the second connector to the transmitting line pair.

In another embodiment, the automatic configuration method further comprises, after step (3), detecting again whether the signal indicating link establishment appears at the receiving line pair, if so, continuing to detect whether the signal appears at the receiving pair; else returning to step (1).

Compared to the prior art, the automatic configuration system and method primarily uses the detecting unit to detect whether the signal indicating link establishment appears at the receiving line pair. When no link is detected, the connections of the first connector and the second connector with the transmitting line pair and the receiving line pair are switched at certain timing to ensure data can be reliably transmitted and received between the node devices in the network. Furthermore, in the present invention, before a communication link is established between the node devices in the network, it is only necessary to provide power to the one of the first and second connectors preset for receiving data, and the automatic configuration system may sequentially control the configurations between the first and second connectors and the transmitting and receiving line pairs at certain timing. Thus, unlike the prior art that requires power to be provided to both lines for transmitting data and receiving data, the automatic configuration system and method saves more power.

### BRIEF DESCRIPTION OF THE DRAWINGS

The present invention can be more fully understood by reading the following detailed description of the preferred embodiments, with reference made to the accompanying drawings, wherein:

FIG. 1 (PRIOR ART) is a schematic diagram of a traditional 10 Base-T Medium Dependent Interface;

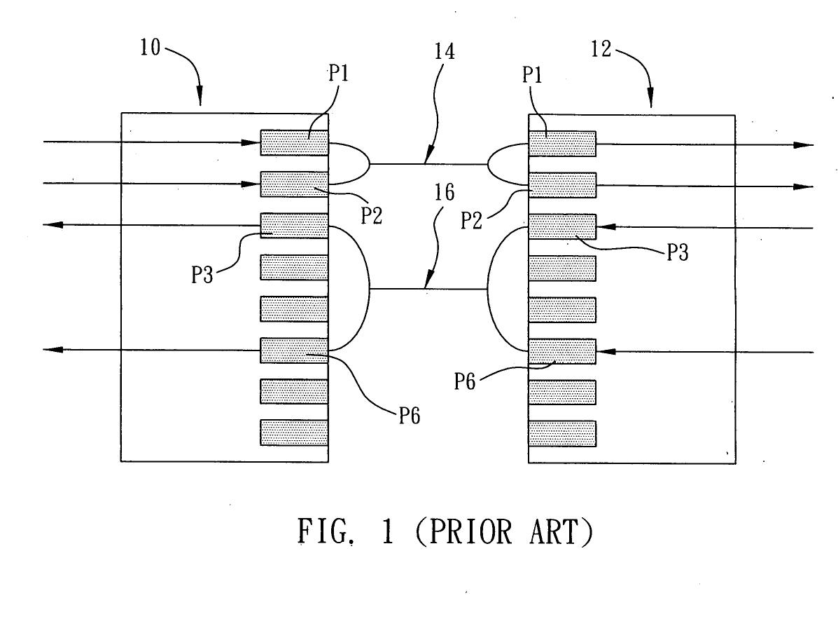

FIG. 2 (PRIOR ART) shows a conventional connecting architecture between two similar node devices;

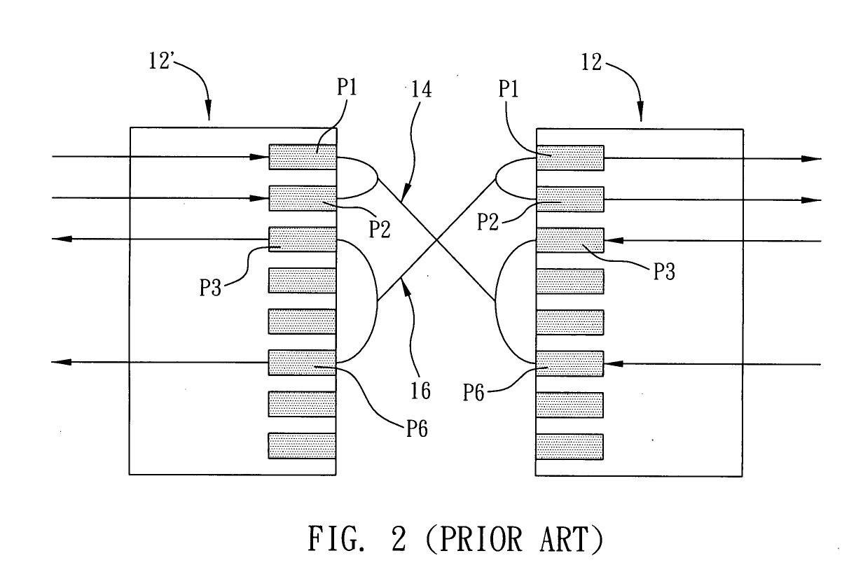

FIG. 3 (PRIOR ART) shows a connecting architecture between a repeater, switch or a hub and a media switch disclosed in U.S. Pat. No. 6,460,078;

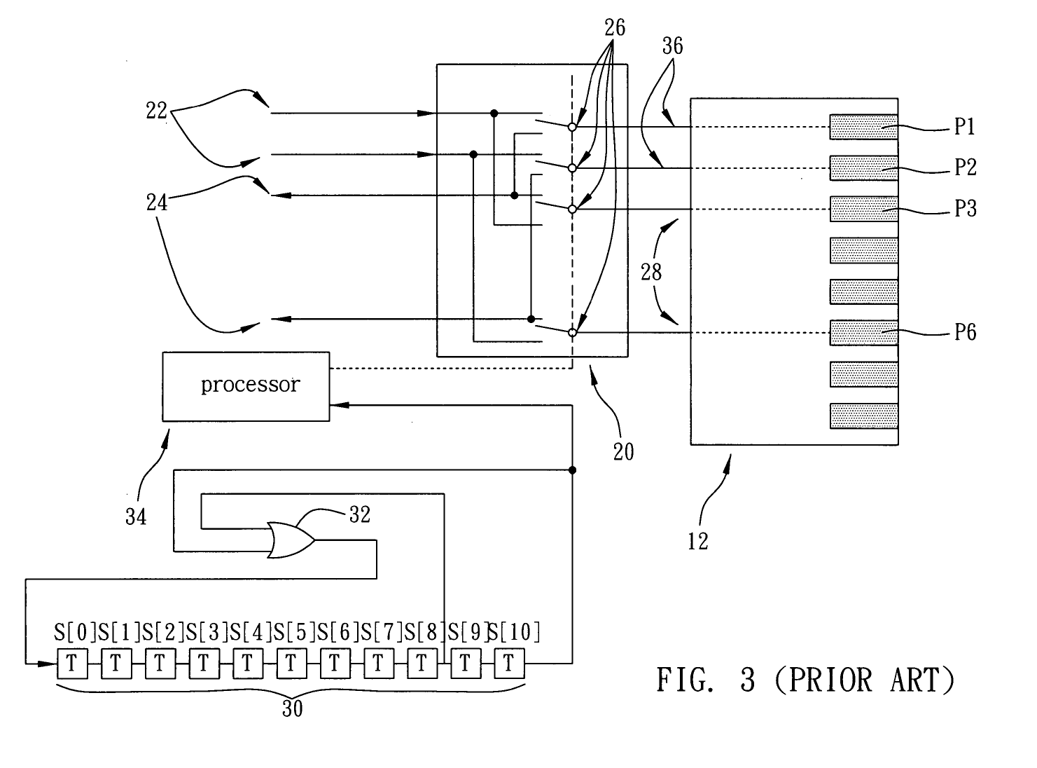

FIG. 4 is a schematic block diagram showing basic architecture of one embodiment of the automatic configuration system of the present invention;

FIG. 5 shows timeslots for receiving data/transmitting data by a receiving end and a transmitting end of a network interface according to one embodiment of the automatic configuration system of the present invention; and

FIG. 6 shows a flowchart of the automatic configuration method of the present invention.

### DETAILED DESCRIPTION OF THE EMBODIMENTS

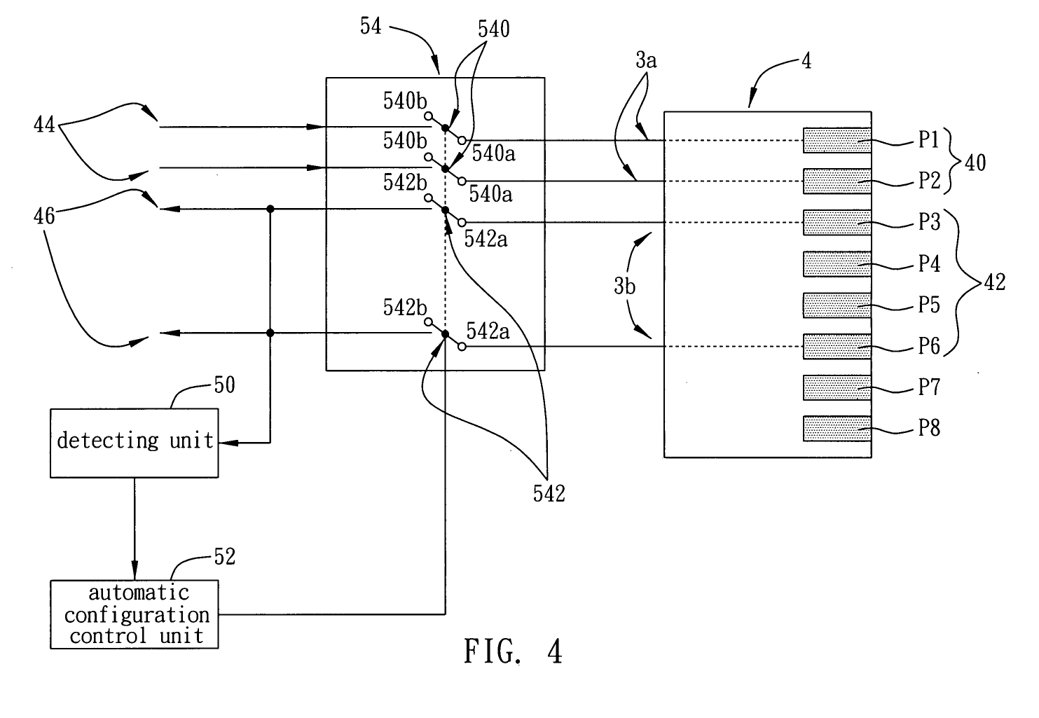

FIG. 4 shows a basic architecture of the automatic configuration system of the present invention, only those related to the present invention are shown.

As shown in FIG. 4, the automatic configuration system of the present invention is applied to a communication network having transmitting and receiving functionalities for automatically configuring network connectors in the communication network as transmitting end or receiving end, such as a connecting interface (e.g. 10 Base-T, 100 Base-T or 1000 Base-T MDI (Media Dependent Interface)) of a node device 4 in a LAN (Local Area Network). The above node device 4 can for example be a NIC (Network Interface Card), a switch, a repeater or a hub. In order to simplify descriptions and drawings, the present invention will be illustrated using NIC as the node device 4, but the present invention is not limited to this. As shown, the connecting interface of the NIC 4 comprises a plurality of contact pins (P1, P2, P3, P6 etc.), wherein the contact pins P1, P2 are used as a first connector 40 and contact pins P3, P6 are used as a second connector 42. One of the connectors 40, 42 is used for transmitting data while the other for receiving data. The above NIC 4 can connect with another node device (not shown) in the network via transmitting line pair (Tx+, Tx−) 44 and receiving line pair (Rx+, Rx−) 46.

As shown in FIG. 4, the automatic configuration system of the present invention comprises (as indicated by dash line) a detecting unit 50, an automatic configuration control unit 52 and a switching unit 54. The detecting unit 50, automatic configuration control unit 52 and switching unit 54 are now described in detail.

The detecting unit 50 detects whether there is a “Signal_Link” signal indicating link establishment at the receiving end in a predetermined time, and outputs detection result. In this embodiment, the detecting unit is used to detect whether there is a “Signal_Link” signal at the receiving line pair 46. The detecting unit comprises a timer. Depending on actual design requirements, the timer can be replaced with similar electrical elements or electrical circuit. The predetermined time can be set by a user in advance as required.

The automatic configuration control unit 52 outputs a control signal to the switching unit 54 based on the detection result from the detecting unit 50.

The switching unit 54 connects the transmitting line pair 44 and the receiving line pair 46 to the NIC 4. The switching unit 54 may connect to the first connector 40 and the second connector 42 of the NIC 4 via connecting lines 3a, 3b. The switching unit 54 may automatically configure, with certain timing, the first connector 40 and the second connector 42 to the transmitting line pair 44 and the receiving line pair 46 based on the control signal of the automatic configuration control unit 52. The switching unit 54 can for example be a media switch or a multiplexer. The present invention will be described using media switch as the switching unit 54, but it is not limited to this. The above switch or multiplexer may be replaced by electrical elements or electrical circuits with similar functions.

As shown in FIG. 4, the media switch 54 comprises a first pair of contacts 540 and a second pair of contacts 542. One end 540a, 542a of the first pair of contacts 540 and the second pair of contacts 542 are connected to the first connector 40 (i.e. contact pins P1, P2) and the second connector 42 (i.e. contact pins P3, P6) of the NIC 4 via connecting lines 3a, 3b, respectively. The other end 540b, 542b of the first pair of contacts 540 and the second pair of contacts 542 are selectively connected to one of the transmitting line pair 44 and the receiving line pair 46.

The present invention is further illustrated in order to clearly facilitate understanding of the principles and effects of the present invention. It is set in advanced that the transmitting line pair 44 selectively connect to the first connector 40 (i.e. contact pins P1, P2) of the NIC 4 via the first pair of contacts 540; the receiving line pair 46 selectively connect to the second connector 42 (i.e. contact pins P3, P6) of the NIC 4 via the second pair of contacts 542. Thereafter, the configuration of connecting interface (i.e. 10 Base_T MDI) of the NIC 4is completed: the contact pins P1, P2 are transmitting pins, contact pins P3, P6 are receiving pins.

Before the NIC 4 transmits/receives data to/from another node device (e.g. a NIC, a switch, a repeater or a network hub), the detecting unit 50 first detects whether there is a “Signal_Link” signal indicating link establishment at the receiving line pair 46, and outputs detection results. Specifically, if the detecting unit 50 detects the “Signal_Link” signal at the receiving line pair, i.e. there is a “Signal_Link” signal at contact pins P3, P6 (second connector 42), it indicates that the configuration preset for the connecting interface of the NIC 4 is correct and the NIC 4 has already established communication with another node device, whereby data can be transmitted/received between the NIC 4 and another node device. If the detecting unit 50 detects no “Signal_Link” signal at the receiving line pair, i.e. there is no “Signal_Link” signal at contact pins P3, P6 (second connector 42), it indicates that the configuration preset for the connecting interface of the NIC 4 is not correct. This means that the contact pins P1, P2 of the NIC 4 preset as the transmitting end are connected to the transmitting pins of another node device while the contact pins P3, P6 of the NIC 4 preset as the receiving end are connected to the receiving pins of another node device, so that no link can be established between the NIC 4 and another node device.

The automatic configuration control unit 52 generates a control signal based on the detection result of the detecting unit 50 to control the operations of the media switch 54. Specifically, if the detecting unit 50 detects the “Signal_Link” signal at the receiving line pair, i.e. there is a “Signal_Link” signal at contact pins P3, P6 (second connector 42) preset for receiving data, indicating that the configuration preset for the connecting interface of the NIC 4 is correct, then the automatic configuration control unit 52, based on the detection result of the detecting unit 50, maintains the current contacting relationship of the first pair of contacts 540 and the second pair of contacts 542 of the media switch 54 with the transmitting line pair 44 and the receiving line pair 46 to ensure reliable transmission/reception of data between the NIC and the another node device on the communication network. If the detecting unit 50 detects no “Signal_Link” signal at the receiving line pair, i.e. there is no “Signal_Link” signal at contact pins P3, P6 (second connector 42) preset for receiving data, indicating that the configuration preset for the connecting interface of the NIC 4 is incorrect, then the automatic configuration control unit 52, based on the detection result of the detecting unit 50, controls the another end 540b of the first pair of contacts 540 to switch from the transmitting line pair 44 to the receiving line pair 46. Thereby, the receiving line pair 46 internally connects to the pins P1, P2 of the NIC 4 via the first pair of contacts 540 and the connecting line 3a, such that the contact pins P1, P2 function as receiving pins. Meanwhile, the second pair of contacts 542 is kept in a floating state and the transmitting line pair 44 is kept in a disabled state.

Thereafter, the detecting unit 50 continues to detect whether the “Signal_Link” signal at the receiving line pair 46, i.e. there is a “Signal_Link” signal at contact pins P1, P2 (first connector 42), indicating that contact pins P1, P2 receives data from the another node device. If so, then the automatic configuration control unit 52 controls the another end 542b of the second pair of contacts 542 of the media switch 54 to switch to the transmitting line pair 44, so that the contact pins P3, P6 of the NIC 4 are internally connected to the transmitting line pair 44 via connecting line 3b, making contact pins P3, P6 as transmitting pins. Then, transmitting line pair 44 can be enabled again to allow data to be transmitted from the pins P3, P6 of the NIC 4 to the another node device. This ensures reliable data transmission/reception while saving power.

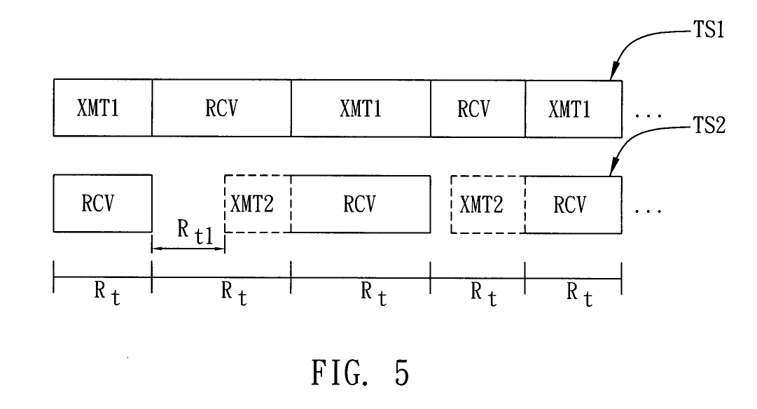

According to the automatic configuration system 1 of the present invention, the attribute (transmitting data or receiving data) of the contact pins P1, P2 and contact pins P3, P6 of the NIC 4 can be automatically configured based on the status of the network link. Please refer in conjunction to FIG. 5, shown are timeslots of contact pins P1, P2 and contact pins P3, P6 of the NIC 4 indicating time intervals of data transmission and reception according to the automatic configuration system 1 of the present invention. As shown, symbol TS1 indicates the timeslot for contact pins P1, P2, and symbol TS2 indicates the timeslot for contact pins P3, P6. Furthermore, the timeslot TS1 comprises intervals of data transmission XMT1 and data reception RCV and the timeslot TS2 comprises intervals of data transmission XMT2 and data reception RCV. The present invention preset the contact pins P1, P2 as transmitting pins in a predetermined random time (Rt), and contact pins P3, P6 as receiving pins. Accordingly, the detecting unit 50 detects whether the “Signal_Link” signal appears on the receiving pins P3, P6 (second connector 42) in a predetermined random time Rt. If so, the automatic configuration control unit 52 maintains the current connecting status of the first and second pairs of contacts 540, 542 of the media switch 54, that is, the configurations of the contact pins P1, P2 and pins P3, P6 are maintained. If no “Signal_Link” signal is detected, then the automatic configuration control unit 52 controls the first pair of contacts 540 of media switch 54 to switch, so now the receiving line pair 46 is connected to the contact pins P1, P2 via connecting line 3a, thus changing the configuration of pins P1, P2 (the attribute of contact pins P1, P2 are changed from transmitting pins to receiving pins). This allows the NIC 4 to send data to another node device at the next predetermined random time Rt. Meanwhile, the second pair of contacts 542 is floated and the transmitting line pair 44 is disabled. Thereafter, the detecting unit 50 may detect again whether the “Signal_Link” signal appears on the receiving pins P1, P2 (first connector 40) in next predetermined random time Rt. If the “Signal_Link” signal is detected, then the automatic configuration control unit 52 controls the second pair of contacts 542 of media switch 54 to switch, so now the receiving line pair 46 is connected to the contact pins P3, P6 via connecting line 3b, thus changing the configuration of pins P3, P6 (the attribute of contact pins P3, P6 are changed from being receiving pins to transmitting pins). After this, the transmitting line pair 44 can be enabled to allow the NIC 4 to transmit data via pins P3, P6. As shown in FIG. 5, in the next predetermined random time Rt, data is transmitted after Rt1 at pins P3, P6. In general, the automatic configuration system 1 of the present invention provides power to the first connector 40 or the second connector 42 as the receiving end to detect whether a network link has been established, and automatically configures pins P1, P2 or pins P3, P6 based on the detected result, then configures pins P3, P6 or pins P1, P2 based on a further detected result by the detecting unit 50, which ensures reliable data transmission/reception. Additionally, since that the present invention detects only one pair of pins P1, P2 and pins P3, P6 to see if a link is established, thus before a stable link is established, it is not necessary to simultaneously provide power to both the transmitting line pair 44 and the receiving line pair 46, which further reduces power consumption.

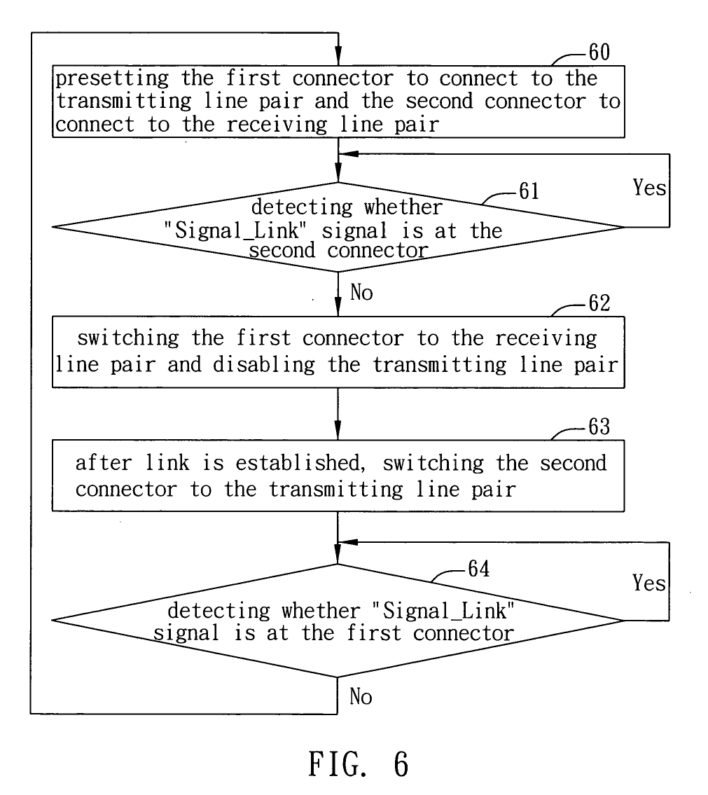

The automatic configuration method of the present invention executing the automatic configuration system 1 of the present invention is shown in FIG. 6. In the automatic configuration method comprises the following steps: In step S60, in a predetermined random time Rt, the transmitting line pair 44 is preset to connect to the first connector 40 (i.e. pins P1, P2) of the NIC 4, so that the first connector 40 acts as the data transmitting end (i.e. pins P1, P2 are transmitting pins) while the receiving line pair 46 is preset to connect to the second connector 42 (i.e. pins P3, P6) of the NIC 4, so that the second connector 42 acts as the data receiving end (i.e. pins P3, P6 are receiving pins). Then, step S61 is performed.

In step S61, the detecting unit 50 detects whether a “Signal_Link” signal indicating link establishment appears at the receiving line pair 46, i.e., whether the “Signal_Link” signal appears at the second connector 42 (pins P3, P6) of the NIC 4 preset as the receiving end. If so, then the configuration in above step S60 is correct, and step S61 is repeated; else, step S62 is performed.

In step S61, the automatic configuration control unit 52 controls the first pair of contacts 540 of the media switch 54 to switch from the transmitting line pair 44 to the receiving line pair 46, so as to internally connect the receiving line pair 46 to the first connector 40 (i.e. pins P1, P2) via the connecting line 3a, and allows the first connector 40 to receive data instead of transmit data (i.e. pins P1, P2 are changed from transmitting pins to receiving pins). Meanwhile, the second pair of contacts 540b is floated and the transmitting line pair 44 is in a disabled state. Next, step S63 is executed.

In step S63, after the first pair of contact 540 of the media switch 54 switches from the transmitting line pair 44 to the receiving line pair 46 such that the first connector 40 (i.e. pins P1, P2) are connected to the receiving line pair 46 via the connecting line 3a so a link is properly established, the automatic configuration control unit 52 allows the transmitting line pair 44 to connect to the second connector 42 (i.e. pins P3, P6) via the connecting line 3b, such that the second connector 42 transmits data instead of receives data (i.e. pins P3, P6 are changed from receiving pins to transmitting pins). Upon which, the transmitting line pair 44 can be enabled for transmission.

The automatic configuration method of the present invention further comprises a step S64, in which the detecting unit 50 further detects whether the “Signal_Link” signal appears at the receiving line pair 46, i.e., whether the “Signal_Link” signal appears at the first connector 40 (pins P1, P2) of the NIC 4 in the next predetermined random time Rt, if so, step S64 is repeated; else step S60 is performed again.

Therefore, the automatic configuration system and method of the present invention detects, in a predetermined time Rt, whether a link is established at the first connector (i.e. pins P1, P2) and or second connector (i.e. pins P3, P6) preset as the receiving end and generates detection result based on the detection, so as to allow the automatic configuration control unit and the switching unit to switch configuration of the connecting interface of a node device (e.g. the connector of a NIC) at certain timing based on the detection result of the detecting unit. Data can be sent to another node device on the communication network after a network link is established, thus ensure reliable data transmission/reception. Additionally, in the present invention, before a network link is established between this node device and another node device on the network, it is only necessary to provide power to one of the connectors preset as the receiving end in order to drive detection of the “Signal_Link” signal at that connector. The configurations of the transmitting line pair and the receiving line pair with the first connector and the second connector are performed sequentially with certain timing by the automatic configuration system and method of the present invention. Compared to the approach of providing power to both the line for transmission and the line for reception in the prior art, the present invention reduces power consumption.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. An automatic configuration system for automatically configuring a connecting interface of a node device on a communication network, wherein the node device comprises a transmitting line pair for transmitting data and a receiving line pair of receiving data, and the connecting interface of the node device comprises a first connector and a second connector, one of the first and second connectors being preset for transmitting data and the other one of the first and second connectors being preset for receiving data, the first connector and the second connector selectively connecting to the transmitting line pair and the receiving line pair to allow the first and second connectors of the node device to couple to a connecting interface of another node device on the communication network so as to exchange data, the automatic configuration system comprising:
a detecting unit for detecting whether a signal indicating link establishment appears at the receiving line pair in a predetermined time so as to detect whether the signal indicating link establishment appears at one of the first connector and the second connector preset for receiving data;
an automatic configuration control unit for generating a control signal based on a detection result by the detecting unit; and
a switching unit for selectively connecting the first connector and the second connector to the transmitting line pair and the receiving line pair at a predetermined timing based on the control signal generated by the automatic configuration control unit.

2. The automatic configuration system of claim 1, wherein if the first connector and the second connector are preset to connect to the transmitting line pair and the receiving line pair, respectively, then the detecting unit detects whether the signal indicating link establishment appears at the second connector preset for receiving data, if so, then the current configuration of the connecting interface is maintained; or else, the automatic configuration control unit controls the switching unit to perform switching based on the detection result of the detecting unit so that the first connector is switched from the transmitting line pair to the receiving line pair and the second connector is disabled, then in a next predetermined time, the detecting unit further detects whether the signal indicating link establishment appears at the first connector, if so, then the automatic configuration control unit controls the switching unit to perform switching so as to connect the second connector to the transmitting line pair.

3. The automatic configuration system of claim 1, wherein the node device is one of a Network Interface Card (NIC), a switch, a repeater and a hub.

4. The automatic configuration system of claim 1, wherein the first connector and the second connector are respectively a plurality of pins of the node device.

5. An automatic configuration method for automatically configuring a connecting interface of a node device on a communication network, wherein the node device comprises a transmitting line pair for transmitting data and a receiving line pair for receiving data, and the connecting interface of the node device comprises a first connector and a second connector selectively connecting to the transmitting line pair and the receiving line pair to allow the first and second connectors of the node device to couple to a connecting interface of another node device on the communication network so as to exchange data, the automatic configuration method comprising the steps of:
(1) presetting one of the first and second connectors to connect to the transmitting line pair and the other one of the first and second connectors to connect to the receiving line pair, then executing step (2);
(2) detecting whether a signal indicating link establishment appears at the receiving line pair in a predetermined time, if so, maintaining the preset connections, or else generating a control signal to switch the one of the first and second connectors preset to connect to the receiving line pair to the transmitting line pair and disable the other one of the first and second connectors, and executing step (3); and
(3) detecting whether the signal indicating link establishment appears at the receiving pair, if so, generating a control signal to switch the other one of the first and second connectors preset to connect to the transmitting line pair to the receiving line pair; or else repeating step (3).

6. The automatic configuration method of claim 5, wherein in the step (1), the first connector is preset to connect to the transmitting line pair and the second connector is preset to connect to the receiving line pair.

7. The automatic configuration method of claim 6, wherein the step (2) comprises detecting whether the signal indicating link establishment appears at the second connector, if so, then maintaining the current configuration; or else, the first connector is switched from the transmitting line pair to the receiving line pair and the second connector is disabled, then after a predetermined time, in the step (3), detecting whether the signal indicating link establishment appears at the first connector, if so, then connecting the second connector to the transmitting line pair.

8. The automatic configuration method of claim 5, further comprising, after the step (3), detecting again whether the signal indicating link establishment appears at the receiving line pair, if so, continuing to detect whether the signal appears at the receiving pair; or else returning to the step (1).

9. The automatic configuration method of claim 5, wherein the node device is one of a Network Interface Card (NIC), a switch, a repeater and a hub.

10. The automatic configuration method of claim 5, wherein the first connector and the second connector are respectively a plurality of pins of the node device.
